(19) United States
(12) Patent Application Publication
(10) Pub. No.: US 2019/0284859 A1
(43) Pub. Date: Sep. 19, 2019

(54) GUIDE SYSTEM FOR FURNITURE PARTS

(71) Applicant: Julius Blum GmbH, Hoechst (AT)

(72) Inventors: Matthias RUPP, Hohenweiler (AT); Christian HAUER, Hoerbranz (AT); Hermann HAEMMERLE, Lustenau (AT); Ingo GASSER, Hoechst (AT); Franz KOHLWEISS, Hard (AT)

(21) Appl. No.: 16/432,405

(22) Filed: Jun. 5, 2019

Related U.S. Application Data
(63) Continuation of application No. PCT/AT2018/060002, filed on Jan. 8, 2018.

(30) Foreign Application Priority Data
Jan. 13, 2017 (AT) A 50023/2017

(51) Int. Cl. E05D 15/26; E05F 3/20

(52) U.S. Cl. CPC E05D 15/264; E05Y 2900/20; E05F 3/20

(57) ABSTRACT

A guide system includes a first and second guide rail for guiding furniture parts. The second guide rail, in the mounted position, extends transversely relative to the first guide rail. A guiding device is connected to the first furniture part, and is movable relative to the first and second guide rails and has a fitting portion for fastening to the first furniture part. A carrier is displaceable relative to the second guide rail and is connected to a second fitting portion for fastening to the second furniture part. A first drive device moves the guiding device, starting from the second guide rail, at least over a region in a direction towards the first guide rail. The guide system has a second drive device for moving the guiding device, starting from the first guide rail, into a position in which the first and second fitting portion are aligned.

### BACKGROUND OF THE INVENTION

The present invention relates to a guide system for guiding a movably-supported first furniture part, in particular a first door wing of a folding door, which is hingedly connected to at least one second furniture part, in particular a second door wing of a folding door, the guide system comprising:
a first guide rail for guiding the furniture parts,
a second guide rail for guiding the furniture parts, wherein the second guide rail, in the mounted position, extends transversely relative to the first guide rail,
a guiding device which is to be connected to the first furniture part, which is movable relative to the first and second guide rail and which has at least one fitting portion for fastening to the first furniture part,
a carrier configured to be displaceable relative to the second guide rail and which is connected to at least one second fitting portion for fastening to the second furniture part,
a first drive device for moving the guiding device, starting from the second guide rail, at least over a region in a direction towards the first guide rail.

The invention further concerns an arrangement comprising two furniture parts hingedly connected to one another, in particular door wings of a folding door, and a guide system of the type to be described. The invention further relates to an item of furniture having such an arrangement or having such a guide system.

WO 2016/081961 A1 and WO 2016/081963 A1 show mechanical drive devices for folding-sliding doors, in which the folding-sliding door can be moved, starting from a lateral compartment in which the door wings adopt a folded together position to one another, into a position outside of the compartment in which the door wings can be spreaded apart relative to one another. A drawback is the fact that the door wings, after the spreading apart operation, are located in an undefined intermediate position.

It is an object of the present invention to propose a guide system mentioned in the introductory part, having a more convenient operating possibility.

### SUMMARY OF THE INVENTION

According to the invention, the guide system includes at least one second drive device for moving the guiding device, starting from the first guide rail, into a position in which the first fitting portion and the second fitting portion are aligned to each other such that the furniture parts, which are connected to the fitting portions in the mounting condition, are aligned substantially coplanar to each other.

By the proposed guide system, it is possible that the furniture parts, in the mounted condition, can be moved from a first position, in which the furniture parts are aligned parallel to one another, into a second position in which the furniture parts are aligned substantially coplanar to one another. By the second drive device, the furniture parts, in the mounted condition, are thus movable into a defined end position, namely in that position in which the furniture parts are aligned substantially coplanar to one another.

It is thereby preferable that the drive devices provided for moving the furniture parts operate exclusively mechanically, i.e. without an electric drive and without further electrical components.

### BRIEF DESCRIPTION OF THE DRAWINGS

Further details and advantages of the present invention will be explained with the aid of the following description of figures, in which:

FIG. 1a, 1b show an item of furniture with a guide system for driving furniture parts which, on the one hand, are located in a countersunk position within a compartment and, on the other hand, in a moved-out position outside the compartment,

FIG. 2a, 2b show the item of furniture according to FIG. 1a, 1b with the furniture parts in two further positions,

FIG. 3a, 3b show the item of furniture with the guide system in a perspective view, and an enlarged detail view thereof,

FIG. 4a, 4b show the guiding device located on the carrier, and an enlarged detail view thereof,

FIG. 5a, 5b show the guide system in a side view, and an enlarged detail view thereof,

FIG. 6a-6d show the retraction operation of the carrier in two successive positions, and enlarged detail views thereof,

FIG. 7a-7d show the ejection operation in two successive positions, and enlarged detail views thereof,

FIG. 8a-8d show continued positions starting from FIG. 7a, 7b, and enlarged detail views thereof,

FIG. 9a, 9b show a possible embodiment for releasably locking between the carrier and the guide rail in two successive positions,

FIG. 10a, 10b show continued positions starting from FIG. 9a, 9b,

FIG. 11a, 11b show the guide system with the carrier in a first position, and an enlarged detail view thereof,

FIG. 12a, 12b show the guide system with the carrier in a second position, and an enlarged detail view thereof,

FIG. 13a, 13b show the guiding device movably supported on the guide rail in a perspective view and in a cross-sectional view,

FIG. 14a-14d show a possible embodiment of a spreading device for spreading the furniture parts apart, and schematic views of the spreading-apart operation,

FIG. 15a, 15b show the second drive device in a perspective view and in a cross-sectional view,

FIG. 16a, 16b show the second drive device in a first relative position in which the furniture parts, in the mounted condition, are aligned parallel to one another, and in a second relative position,

FIG. 17a, 17b show the second drive device in a third relative position and in a fourth relative position in which the furniture parts, in the mounted condition, are aligned coplanar to one another,

FIG. 18 shows the second drive device in an exploded view.

### DETAILED DESCRIPTION OF THE INVENTION

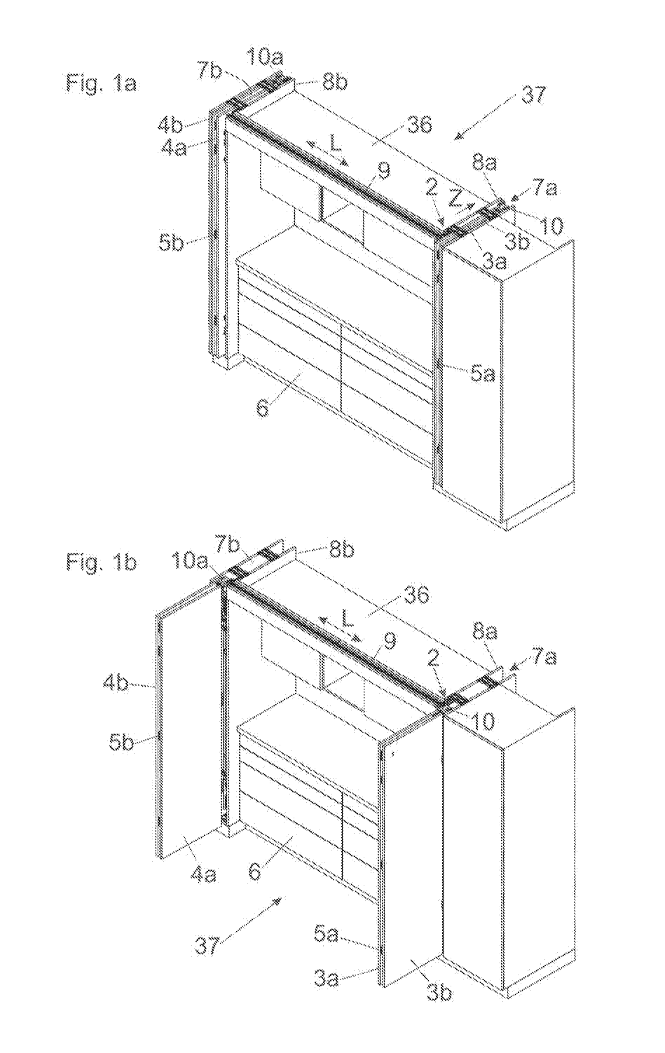

FIG. 1a shows a possible application of a guide system 2 for guiding a first furniture part 3a, preferably in the form of a first door wing of a folding door, in which the first furniture part 3a, in the mounted condition, is hingedly connected via a vertically extending axis 5a to a second furniture part 3b in the form of a second door wing. Optionally, at least two further furniture parts 4a, 4b may be provided which are also pivotally connected to one another by a vertically extending axis 5b. The furniture parts 3a, 3b and 4a, 4b are movably supported by the guide system 2 relative to a furniture carcass 36 of an item of furniture 37, and the furniture carcass 36 is stationary during operation. The guide system 2 may be used, for example, as a room partitioning system, so that in a living area, a furniture carcass 6 as shown in FIG. 1a in the form of a kitchen block, an office niche, a storage room, a shelf, etc. may entirely be covered by the furniture parts 3a, 3b; 4a, 4b and can be optically separated from the remaining space of the living area. The guide system 2 may also be used for cabinet systems, for example a walk-in closet. The functionality will be explained in the following with the aid of the furniture parts 3a and 3b, and the same applies to the furniture parts 4a, 4b.

The furniture parts 3a, 3b are movably supported by the guide system 2 between a first position, in which the furniture parts 3a, 3b are aligned substantially parallel to one another (FIG. 1a), and a second position, in which the furniture parts 3a, 3b are aligned substantially coplanar to one another. In the first position, the furniture carcass 6 is freely accessible for a person, and the two furniture parts 3a, 3b can be accommodated in a space-saving manner within an insertion compartment 7a arranged laterally besides the side wall 8a. The two other furniture parts 4a, 4b, in a parallel position to one another, can also be accommodated within a further lateral insertion compartment 7b.

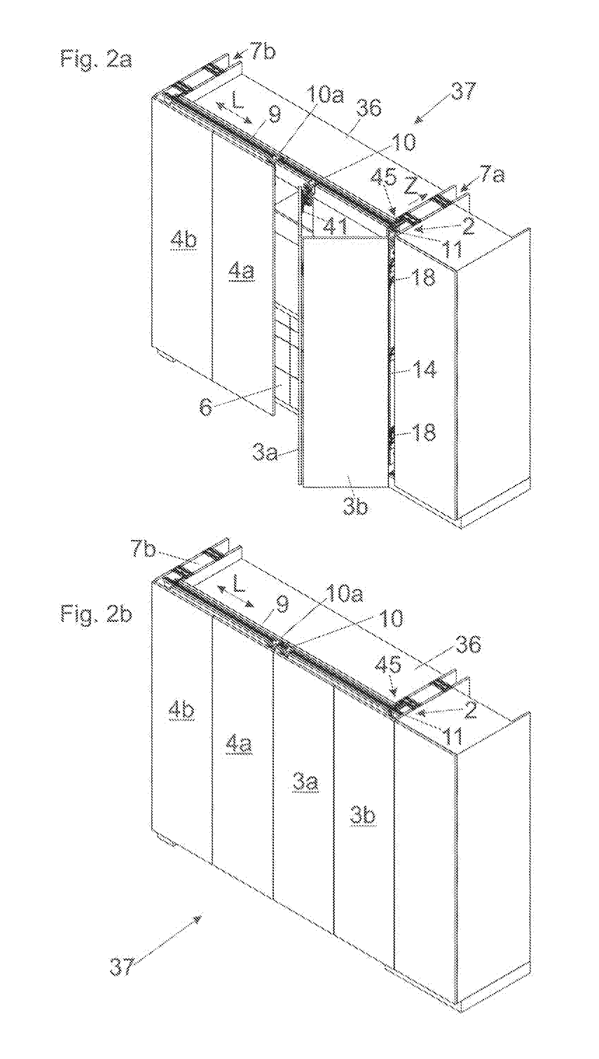

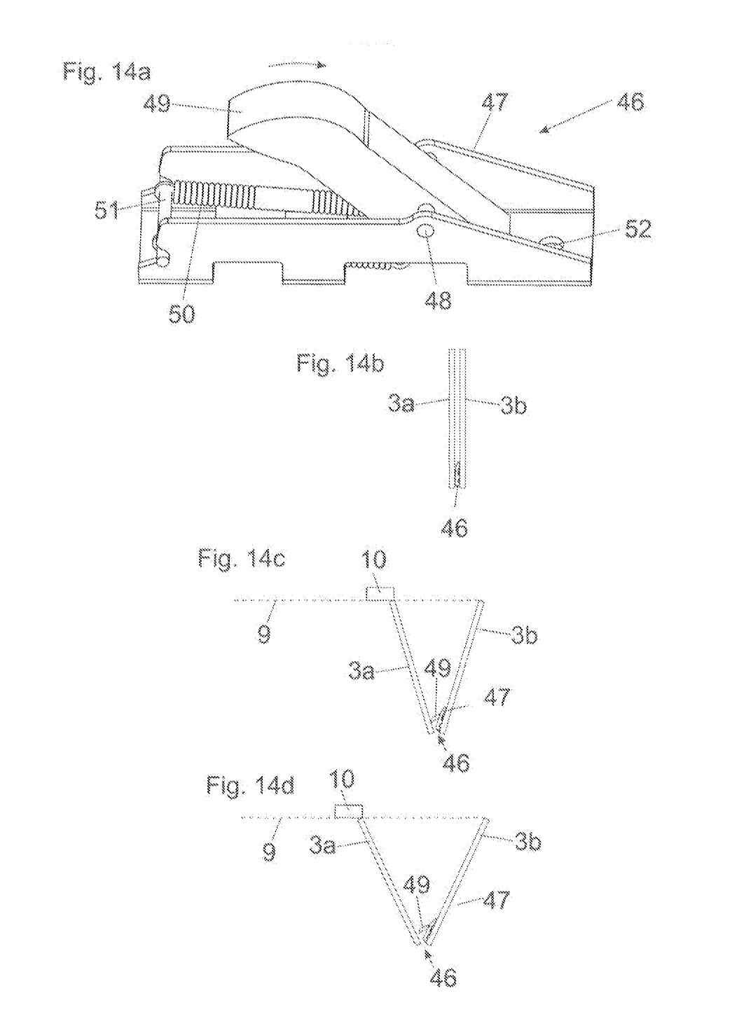

The guide system 2 includes a first guide rail 9 with a longitudinal direction (L) for guiding the furniture parts 3a, 3b. For example, the first guide rail 9 may be fixed to a ceiling of a room, to a wall of a room or also to the stationary furniture carcass 36. The guide system 2 further includes at least one second guide rail 13a (not shown here) extending transversely to the longitudinal direction (L) of the first guide rail 9 in the mounted condition and by which the furniture parts 3a, 3b can be moved in a direction (Z) and in a direction opposite the direction (Z). Moreover, a guiding device 10 (FIG. 2a) is provided configured to be connected to the first furniture part 3a and configured to be moved relative to the first and second guide rails 9, 13a. The two other furniture parts 4a, 4b are movably supported by a separate guiding device 10a. Starting from the position shown in FIG. 1a, in which the furniture parts 3a, 3b adopt a parallel position to one another and are thereby accommodated within the lateral insertion compartment 7a, the furniture parts 3a, 3b can be moved, by a mechanical force application, in a direction (Z) into an overpressing position, whereby a first drive device 12 (not shown here) can be triggered. After the first drive device 12 has been triggered, the furniture parts 3a, 3b can be moved by the first drive device 12 into the position shown in FIG. 1b, in which the furniture parts 3a, 3b are located outside the insertion compartment 7a and still adopt substantially a parallel position to one another. Starting from the position shown in FIG. 1b, the two furniture parts 3a, 3b—if required—can be moved by a spreading device 46 (FIG. 14a) from the parallel position to one another into a spreaded-apart position, so that the furniture parts 3a, 3b adopt an angled position relative to one another.

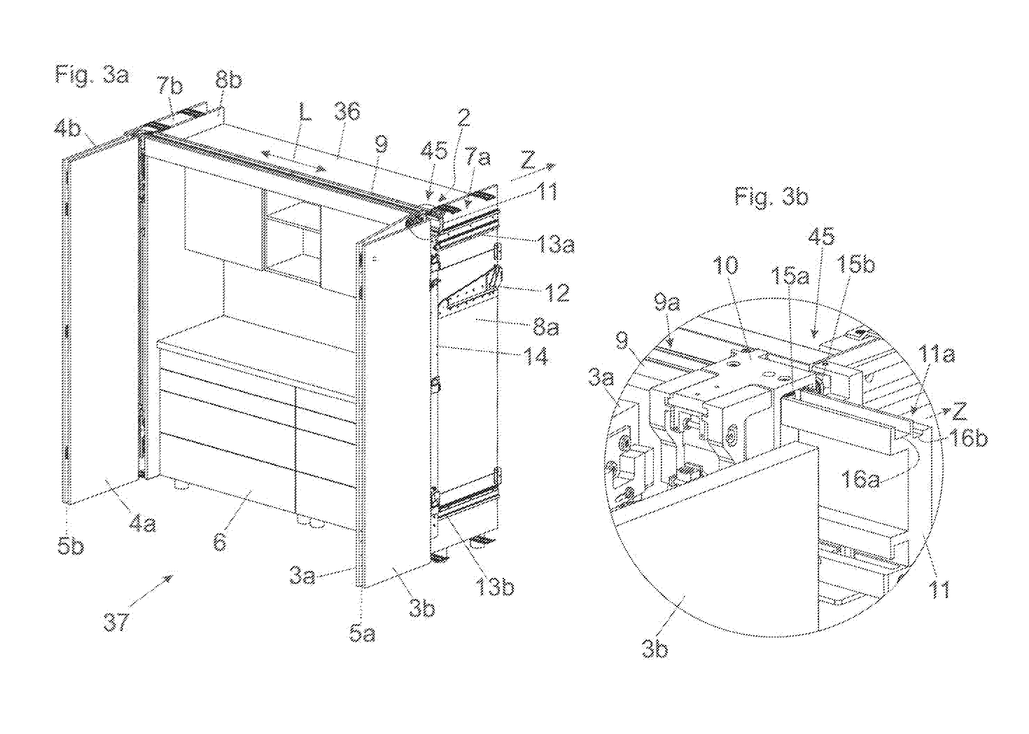

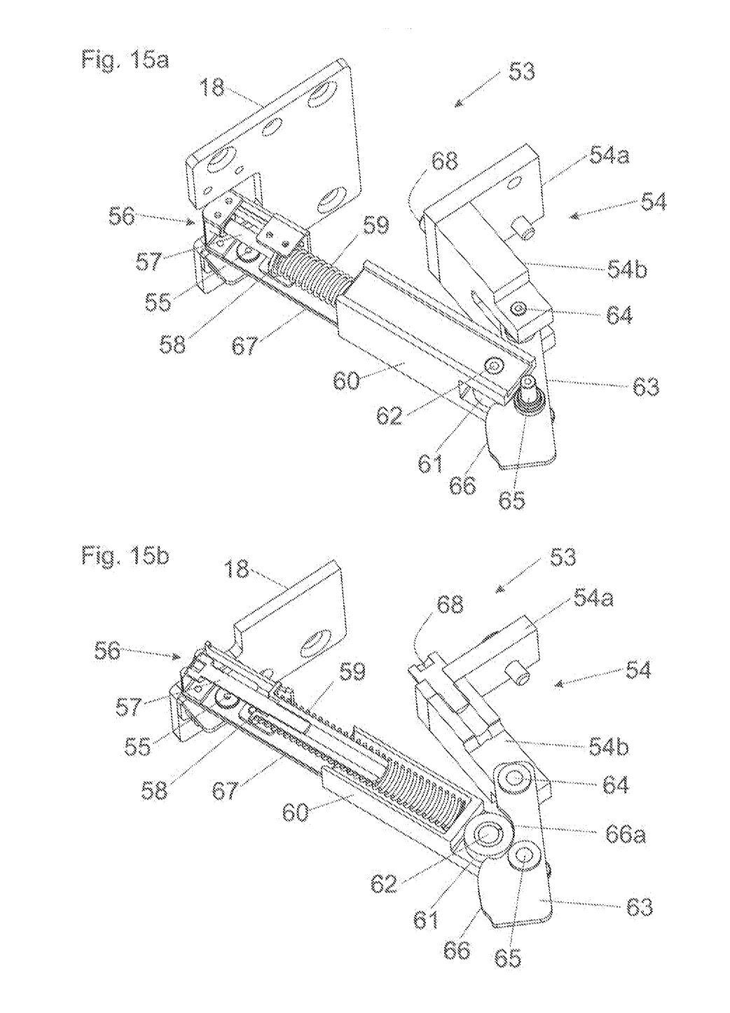

FIG. 2a shows, in relation to FIG. 1b, a continued movement of the furniture parts 3a, 3b to one another. The two furniture parts 4a, 4b have already been moved into a position in which the furniture parts 4a, 4b are aligned coplanar to one another and thereby cover the furniture carcass 6. The guiding device 10 includes at least one first fitting portion 41 for fixing to the first furniture part 3a. The guide system 2 includes a carrier 11 (FIG. 3b) which is movably mounted in a direction transverse to the longitudinal direction (L) of the first guide rail 9 and which is connected to at least one second fitting portion 18 for fixing to the second furniture part 3b. In the shown embodiment, the carrier 11 is connected to a vertically extending column 14 configured to be moved, together with the carrier 11, in the direction (Z) extending transversely to the longitudinal direction (L) of the first guide rail 9. Two or a plurality of fitting portions 18 may be arranged on the vertical column 14 for the movable support of the second furniture part 3b, and the fitting portions 18 are spaced from each other in a height direction of the column 14. The guiding device 10 connected to the first furniture part 3a is configured to be transferred in a crossing region 45—seen in a top view onto the first and second guide rails 9, 13a in the mounting position—to and from between the first and second guide rail 9, 13a. By a second drive device 53 (FIG. 15a), the guiding device 10 can be moved starting from the first guide rail 9 in a position in which the first fitting portion 41 of the guiding device 10 and the second fitting portion 18 are aligned such that the furniture parts 3a, 3b, which are connected to the fitting portions 41, 18 in the mounting condition, are aligned substantially coplanar to each other, as shown in FIG. 2b.

FIG. 3a shows the item of furniture 37 in a perspective view, in which the first guide rail 9 and the at least one second guide rail 13a for guiding the furniture parts 3a, 3b are visible. In the shown embodiment, two second guide rails 13a, 13b are provided which are spaced from each other in a height direction. The carrier 11, together with the column 14 connected thereto, can be moved in the direction (Z) and in a direction opposite the direction (Z). The first guide rail 9 and the second guide rail 13a can be configured as separate components which, in the mounted condition, can adopt a same height position or also a different height position. Alternatively, it is also possible that the first guide rail 9 and the second guide rail 13a have a one-piece configuration and are connected to one another by a curved portion. The crossing region 45, in a top view, is that region in which the guide rails 9, 13a or notional extensions of the guide rails 9, 13a intersect with one another. The guide system 2 includes a first drive device 12 for moving the guiding device 10 can be moved, starting from the second guide rail 13a, at least over a region in a direction of the first guide rail 9, and/or can be retracted, starting from the crossing region 45, at least over a region along the second guide rail 13a.

FIG. 3b shows the region encircled in FIG. 3a in an enlarged view. The first furniture part 3a is connected to a guiding device 10 for moving the furniture parts 3a, 3b along the first and second guide rails 9, 13a. Visible is a carrier 11 configured separate from the first guide rail 9, the carrier 11 being in the form of a displaceable slider which adjoins the first guide rail 9 in a longitudinal direction (L) such that the guiding device 10 connected to the first furniture part 3a can be transferred to and from between the first guide rail 9 and the carrier 11. The guiding device 10 can include at least one first running wheel 15a having a vertical rotational axis for absorbing lateral forces, and at least one second running wheel 15b having a horizontal rotational axis for absorbing vertical forces. The running wheels 15a, 15b are movably arranged in a profiled section 9a of the first guide rail 9, the profiled section 9a extending in the longitudinal direction (L). The carrier 11 also includes a profiled section 11a with a cross-section corresponding to the form and size of the profiled section 9a in cross-sectional view, so that the guiding device 10 can be transferred to and from between the first guide rail 9 and the carrier 11. For example, the carrier 11 can have at least two guide channels 16a, 16b extending in the longitudinal direction (L) for guiding the running wheels 15a, 15b.

The guiding device 10 configured to be displaceable along the first guide rail 9, in the shown transfer position of the carrier 11, is still located on the first guide rail 9. The carrier 11, in the transfer position, can be releasably locked to the first guide rail 9, and that locking can be released by a movement of the guiding device 10 in or on the carrier 11. After the carrier 11 has been unlocked, the carrier 11 can be moved—together with the guiding device 10 and the two furniture parts 3a, 3b—horizontally in the direction (Z) extending transversely, preferably at a right angle, to the longitudinal direction (L) of the first guide rail 9. The carrier 11 is connected to the vertically extending column 14 which is configured to be driven by the first drive device 12 at least over a region in the direction (Z) and/or in a direction opposite the direction (Z). The column 14 is movably supported relative to the second guide rails 13a, 13b which, in the mounted condition, are spaced from the first guide rail 9 in a height direction.

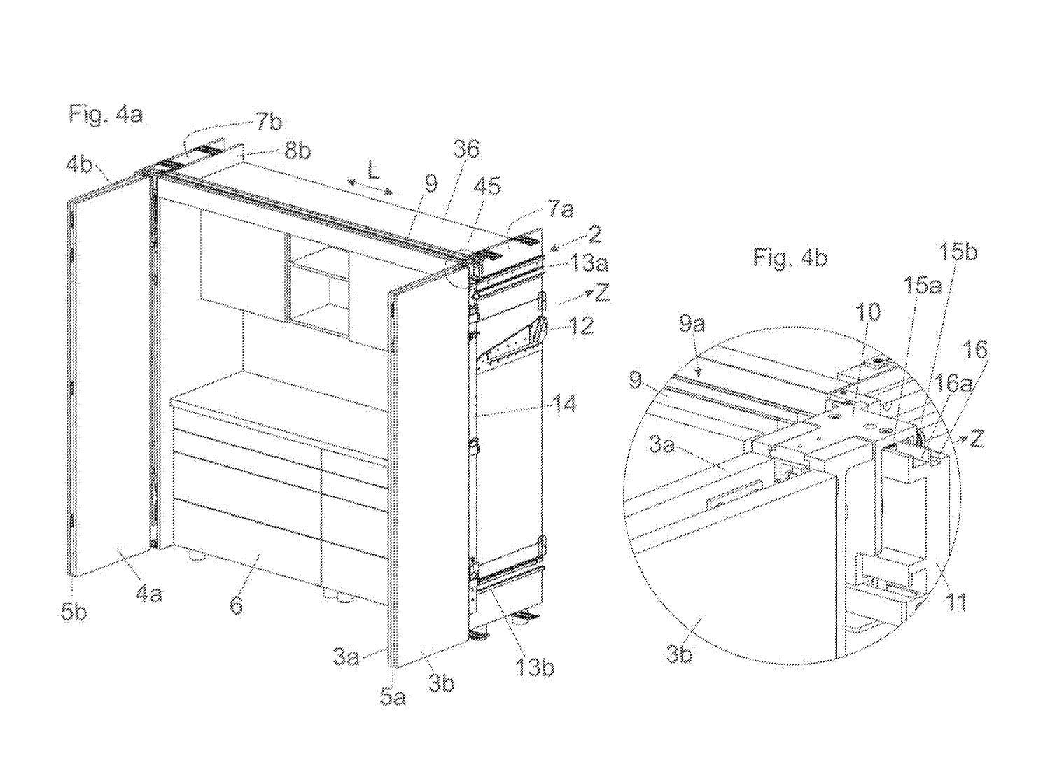

FIG. 4a shows the furniture parts 3a and 3b, after having been pivoted to one another starting from FIG. 3a about the vertical axis 5a and now adopt substantially a parallel position to one another. FIG. 4b shows the encircled region of FIG. 4a in an enlarged view, in which the guiding device 10 is arranged on the carrier 11 being located in the transfer position. It can be provided that a length of the carrier 11 measured in a longitudinal direction (L) is greater than a width of the guiding device 10 measured in the longitudinal direction (L). The profiled section 9a of the first guide rail 9 and the profiled section 11a of the carrier 11 are configured so as to be identical in a cross-sectional view and are aligned flush to one another in the transfer position, so that the running wheels 15a, 15b of the guiding device 10 can be moved between the first guide rail 9 and the carrier 11 without a disturbing abutting edge. Starting from the position shown in FIG. 4b, the carrier 11, together with the guiding device 10 (and therewith the furniture parts 3a, 3b) can be driven by a force of the first drive device 12 at least over a region in the direction (Z).

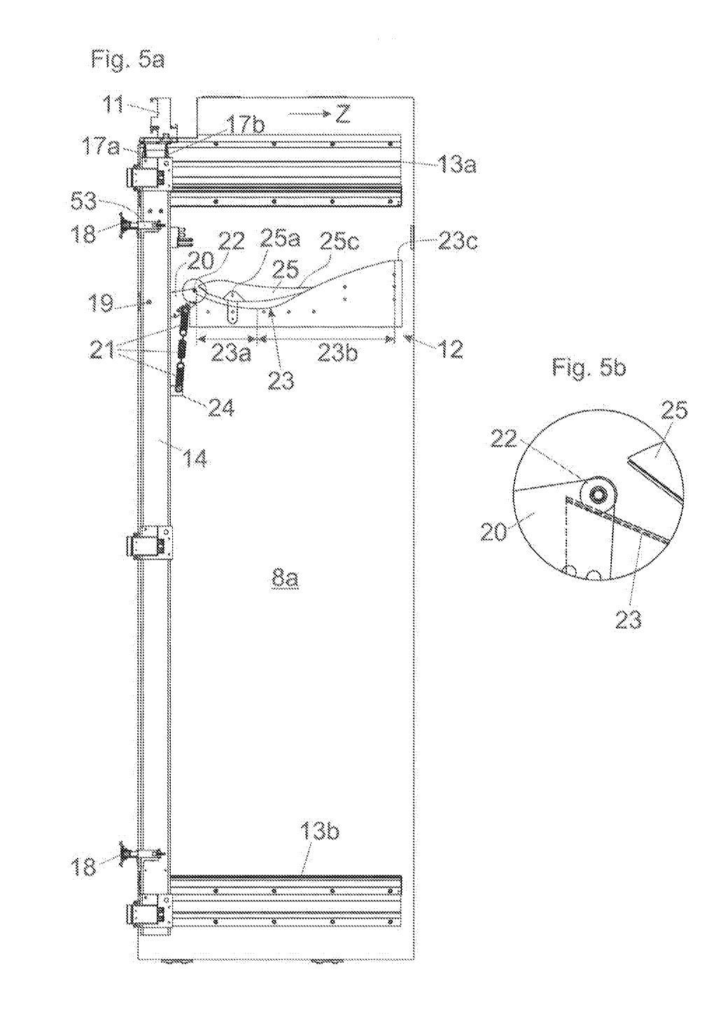

FIG. 5a shows a side view of the carrier 11 located in the transfer position, the carrier 11 being connected to the vertically extending column 14. The column 14, together with the carrier 11, is displaceable in the direction (Z)—for example by supporting rollers 17a, 17b—along the second guide rails 13a, 13b fixed to the side wall 8a. At least one fitting portion 18 is arranged on the column 14 for the movable support of the furniture part 3b, and it is preferably provided that the fitting portion 18 forms part of the second drive device 53 (FIG. 15a, 15b) by which the furniture parts 3a, 3b can be moved from a parallel position to one another into a coplanar position to one another. Arranged on the column 14 is a bearing portion 24 to which at least one, preferably a plurality of, force storage member(s) 21 of the first drive device 12 for retracting the furniture parts 3a, 3b in the direction (Z) is or are anchored. The force storage members 21, in the shown figure, are each configured as tension springs engaging on an entrainment member 20 pivotally mounted on the column 14 about a pivoting axis 19. A pressure roller 22 is pivotally arranged on the entrainment member 20, and the pressure roller 22 can be pressed against a concave-shaped control curve 23 of the first drive device 12 and can be displaced along that control curve 23 upon a movement of the column 14 in the direction (Z). The control curve 23 includes a retraction section 23a for partially retracting the carrier 11 in the direction (Z), and a tensioning section 23b adjoining the retraction section 23a for loading the force storage members 21. In FIG. 5a, the force storage members 21 are in a tensioned condition, so that the column 14 (and therewith the carrier 11), after unlocking of the carrier 11, can be retracted from the first guide rail 9 along the retraction section 23a by a force of the discharging force storage members 21 towards the lowest region of the control curve 23. In this way, the furniture parts 3a, 3b are also partially retracted into the insertion compartment 7a, whereby the furniture parts 3a, 3b are advantageously prepositioned for a continued movement into the insertion compartment 7a in the direction (Z). By a subsequent manual application of pressure to the furniture parts 3a, 3b aligned parallel to one another, in the region of the pivoting axis 5a, the column 14 (and therewith the pressure roller 22) are further moved in the direction (Z) along the tensioning section 23b of the control curve 23, whereby the force storage members 21 are again loaded. When the pressure roller 22 of the entrainment member 20 reaches the end section 23c of the control curve 23, the force storage members 21 are fully loaded, so that the furniture parts 3a, 3b can be moved upon an outward movement starting from a position, in which the furniture parts 3a, 3b are fully inserted into the insertion compartment 7a, at least partially in a direction opposite the direction (Z) by the energy storage members 21. Moreover, a movably-mounted switch member 25 with a setting contour 25c is provided, wherein it is preferably provided that the switch member 25 is configured to be tilted about a pivoting axis 25a. The pressure roller 22 can be displaced, starting from the aforesaid inserted position, along the setting contour 25c of the switch member 25 upon a movement opposite the direction (Z). As a result, the pressure roller 22 pressurized by the force storage members 21 needs not to overcome the hindering retraction section 23a of the control curve 23 upon a movement opposite the direction (Z), so that the retraction section 23a can be bypassed by the pressure roller 22 and a force of the force storage members 21 can be maintained over a longer displacement path. FIG. 5b shows the region encircled in FIG. 5a in an enlarged view.

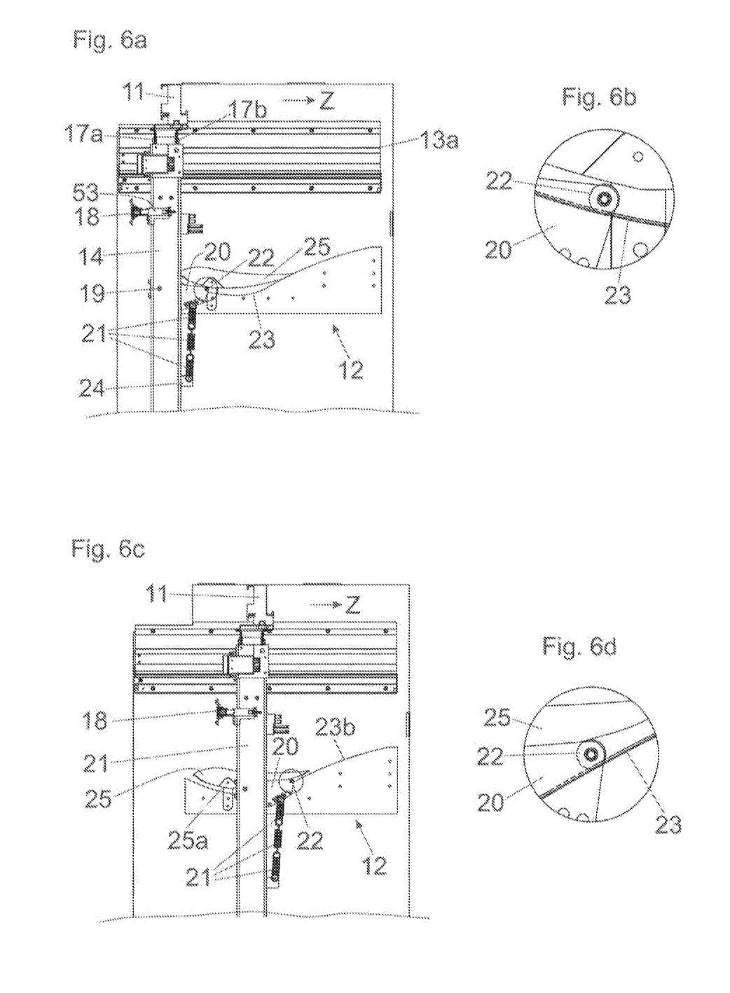

FIG. 6a shows a continued movement of the column 14 (and therewith of the carrier 11) in the direction (Z). Due to the reducing distance between the control curve 23 in the retraction section 23a (FIG. 5a) in relation to the bearing portion 24, the force storage members 21 relax and thereby pull the column 14 and the carrier 11 in the direction (Z). FIG. 6b shows the region encircled in FIG. 6a in an enlarged view. When the pressure roller 22 reaches the lowest region of the control curve 23, the pressure roller 22 is moved to the tensioning section 23b of the control curve 23 by applying a manual force to the furniture parts 3a, 3b, so that the force storage members 21 can be again loaded. The switch member 25 configured to be tilted about the pivoting axis 25a is thereby lifted by the pressure roller 22 (FIG. 6c), so that the pressure roller 22 can pass the switch member 22 in an unhindered manner upon a movement in the direction (Z) and can further be moved along the tensioning section 23b. Due to the eccentric arrangement of the switch member 25 about the pivoting axis 25a, a two-armed lever with lever arms of different lengths is formed, so that the switch member 25 with the longer lever arm loosely rests, preferably exclusively loaded by the force of gravity, against the tensioning section 23b of the control curve 23. If appropriate, the switch member 25 can also be pressed against the control curve 23 by a spring element. FIG. 6d shows the region encircled in FIG. 6c in an enlarged view.

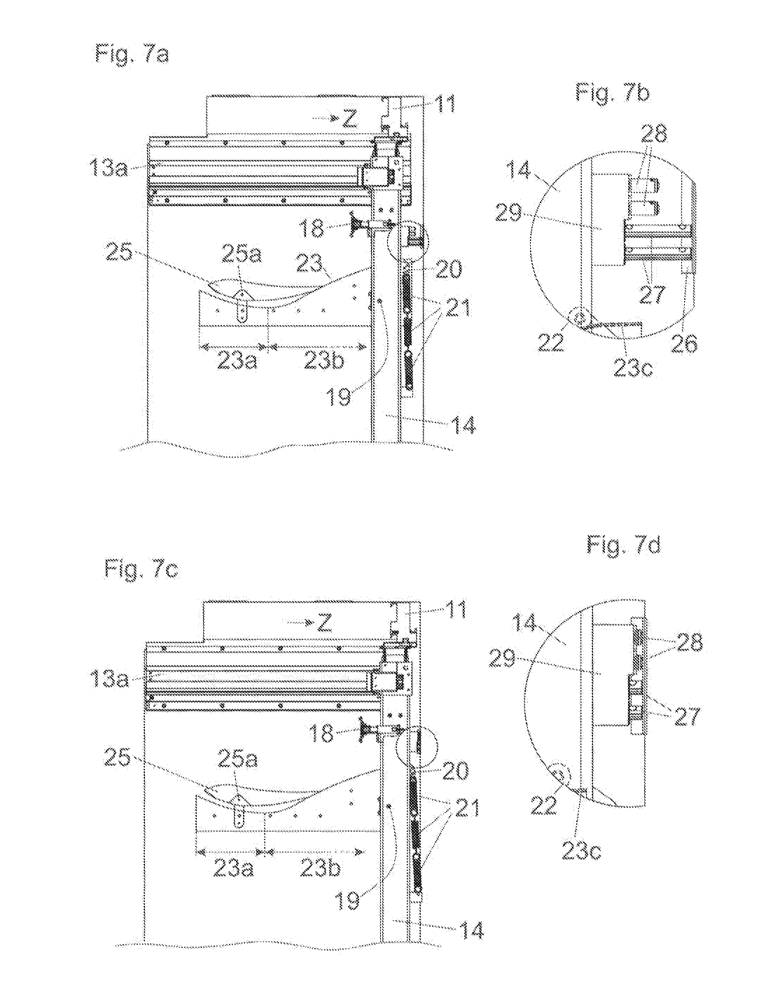

FIG. 7a shows the position of the column 14 right before reaching the fully inserted end position within the insertion compartment 7a. The pressure roller 22 has been moved along the tensioning section 23b of the control curve 23 and is located right before the horizontally extending end section 23c of the control curve 23, so that the column 14 is neither accelerated in the direction (Z) nor in a direction opposite the direction (Z). The force storage members 21 are thereby fully loaded. Arranged on the column 14 is a housing 29 in which a damping device 27 for dampening a closing movement of the column 14 and the carrier 11, respectively, is arranged. In the shown embodiment, the damping device 27 includes two, preferably hydraulic, linear dampers switched in a parallel relationship, and each of the linear dampers has a piston-cylinder-unit. These linear dampers, at the end of the closing movement of the column 14, hit against a stationary abutment portion 26, whereby the rams of the linear dampers are pressed-in and therewith the movement of the column 14 can be decelerated. Moreover, two ejection devices 28 are arranged in the housing 29, the ejection devices 28 each have a lockable energy storage member, and the two rams of the ejection devices 28 are configured to cooperate with the abutment portion 26 upon a closing movement of the column 14, so that the energy storage members of the ejection devices 28 can be loaded and can be locked in a loaded condition. FIG. 7b shows the region encircled in FIG. 7a in an enlarged view.

FIG. 7c shows the end position of the column 14, and the last closing movement of the column 14 has been decelerated by the damping device 27 and the lockable energy storage members of the ejection devices 28 are in a loaded condition. By overpressing the column 14, starting from its closed position, into an overpressing position located behind the closed position, the ejection devices 28 can be moved into an unlocking position, whereupon the column 14 can be again driven by a force of the ejection devices 28 and, subsequently, by a force of the loaded force storage members 21 in a direction opposite the direction (Z). FIG. 7d shows the region encircled in FIG. 7c in an enlarged view.

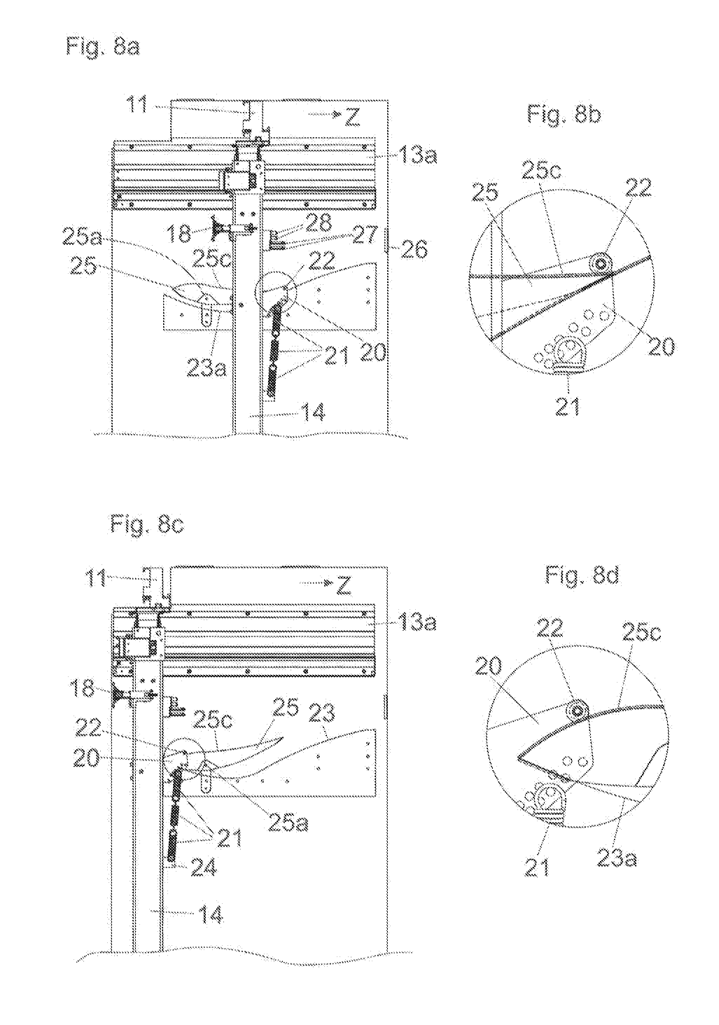

FIG. 8a shows a position of the column 14, after ejection of the ejection devices 28 in a direction opposite the direction (Z) has been performed. The pressure roller 22 is thereby located in a position entering the switch member 25. The pressure roller 22, upon a movement in a direction opposite the direction (Z), is configured to be displaced no longer along the retraction section 23a, but along the setting contour 25c arranged or formed on the switch member 25. In this way, a uniformly-extending ejection operation of the column 14 and of the furniture parts 3a, 3b, respectively, can be brought about, without substantial oscillations in the force of the force storage members 21, and the force of the force storage members 21 is maintained over a longer displacement path. FIG. 8b shows the region encircled in FIG. 8a in an enlarged view, in which the pressure roller 22 moves onto the setting contour 25c of the switch member 25 upon a movement of the column 14 in a direction opposite the direction (Z), without the pressure roller 22 needs to be displaced along the trough portion of the retraction section 23a.

FIG. 8c shows a continued movement of the column 14 in a direction opposite the direction (Z), in which the pressure roller 22 has been moved along the setting contour 25c of the switch member 25 and in which the switch member 25 has been pivoted about the pivoting axis 25a in a counterclockwise direction. By this pivoting movement of the switch member 25 about the pivoting axis 25a, the pressure roller 22 is again returned to the initial region of the retraction section 23a. After the pressure roller 22 has abandoned the setting contour 25c of the switch member 25, the switch member 25 pivots about the pivoting axis 25a back into its initial position, i.e. in that position in which the longer lever arm of the switch member 25, in turn, rests against the control curve 23 due to its heavier weight.

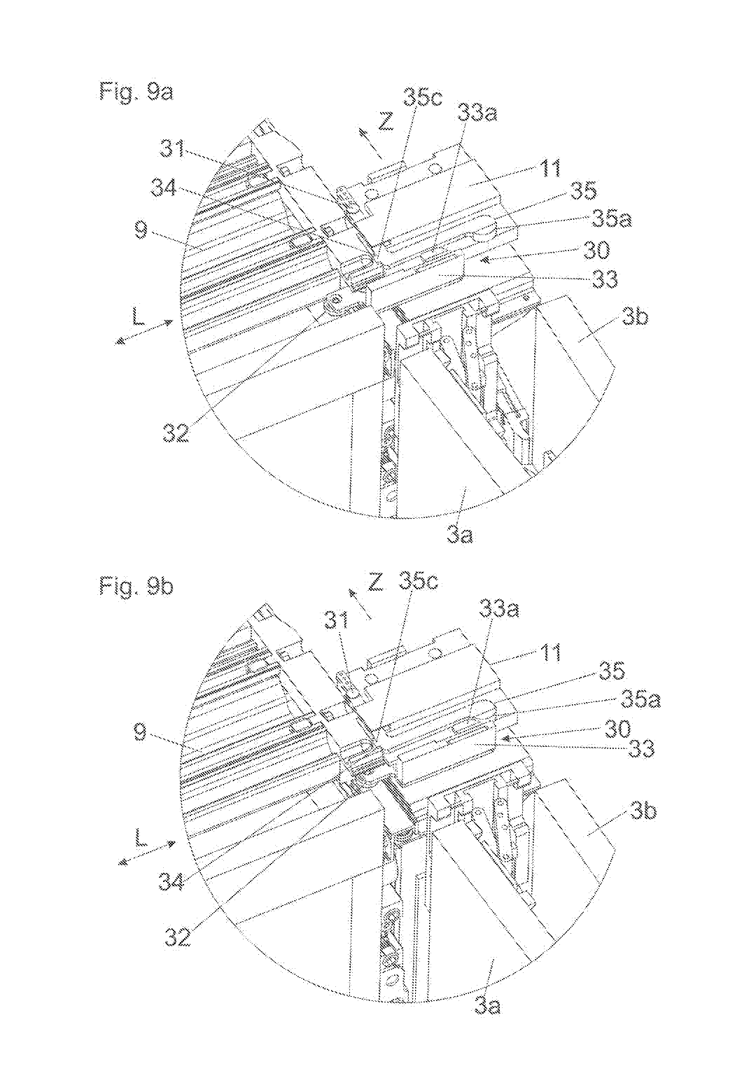

FIG. 9a and FIG. 9b show a possible embodiment of a locking device 30 for locking the carrier 11, in the transfer position or in a parking position, to the first guide rail 9. The locking device 30 is configured to be unlocked by a movement of the guiding device 10 into or onto the carrier 11. The first furniture part 3a is connected to the guiding device 10 configured to be moved in the longitudinal direction (L) along the first guide rail 9. A displacement piece 33 is motionally coupled to the guiding device 10, so that upon a movement of the guiding device 10 along the first guide rail 9, the displacement piece 33 also moves therewith. The displacement piece 33 has a protrusion 33a which, upon a movement in or on the carrier 11, is configured to cooperate with a counterstop 35a of a coupling lever 35 (FIG. 9b). The coupling lever 35 is pivotally mounted about a pivoting axis 31, and a locking element 35c can be moved by the coupling lever 35. The locking element 35c engages into a corresponding recess 34 of the first guide rail 9 in the locking position and thereby locks the carrier 11 relative to the first guide rail 9. It can be provided that the coupling lever 35, together with the locking element 35c, has a one-piece configuration. The coupling lever 35 can be prestressed in a direction of the locking position by a spring (not shown), so that the carrier 11, upon a movement of the carrier 11 in a direction opposite the direction (Z), can be automatically locked to the first guide rail 9 by a force of that spring, and the guiding device 10 can be again transferred back starting from the carrier 11 to the first guide rail 9.

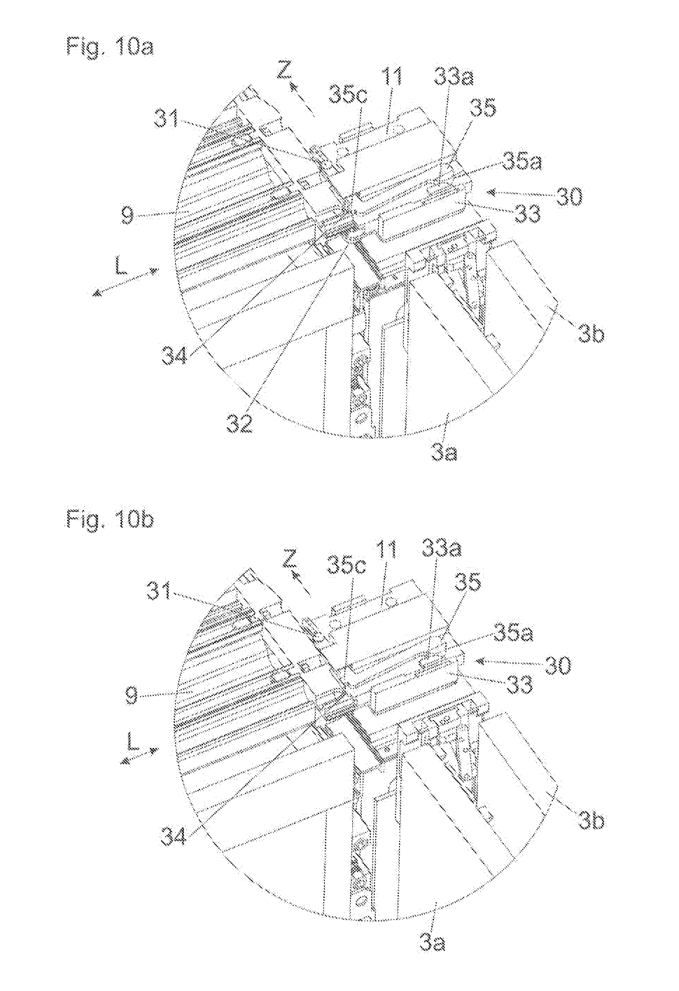

FIG. 10a and FIG. 10b show a continued movement of the displacement piece 33 motionally coupled to the guiding device 10 in the longitudinal direction (L), in which the protrusion 33a of the displacement piece 33 cooperates with the counterstop 35a of the coupling lever 35, and therewith pivots the coupling lever 35 about the pivoting axis 31. As a result, the locking element 35c is moved out from the recess 34 of the first guide rail 9, whereby the carrier 11 is released relative to the first guide rail 9 in order for a movement in the direction (Z) to be enabled. After unlocking has been effected, the carrier 11—together with the column 14—can be retracted at least partially in the direction (Z) by a force of the force storage members 21 of the above-described first drive device 12, and a spacing roller 32 pivotally mounted to the displacement piece 33 for laterally guiding the carrier 11 in the direction (Z) is configured to run along the side wall 8a.

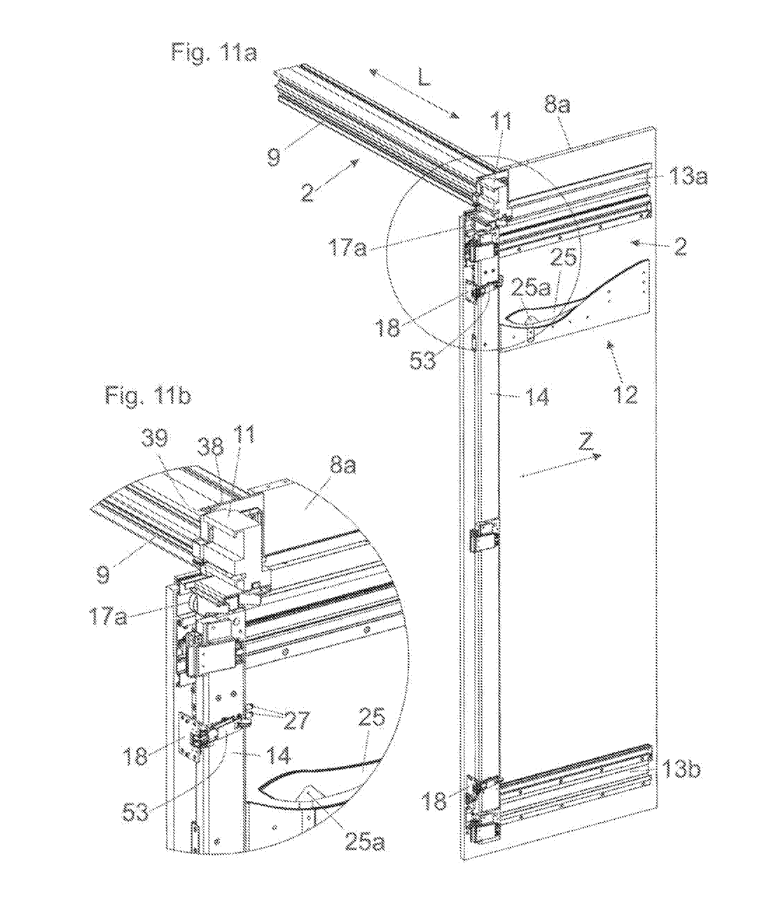

FIG. 11a shows the guide system 2, in which the carrier 11 can be locked to the first guide rail 9 by the above-described locking device 30 and in which the carrier 11 can be moved from the transfer position in a direction (Z) extending transversely to the longitudinal direction (L). On the side wall 8a, which can partially form the insertion compartment 7a, second guide rails 13a and 13b and the switch member 25 tiltable about the pivoting axis 25a are attached, the second guide rails 13a, 13b are provided for the displaceable support of the column 14.

FIG. 11b shows the region encircled in FIG. 11a in an enlarged view, in which the carrier 11 has already been moved out from the transfer position and has slightly been moved in the direction (Z). For limiting a movement of the carrier 11 in a direction opposite the direction (Z), at least one abutment element 38 is arranged on the carrier 11. The abutment element 38 is configured to abut against a counterstop 39 of the first guide rail 9 and therewith prevents a further movement of the carrier 11 in a direction opposite the direction (Z). For the displaceable support of the carrier 11 and the column 14, at least one supporting roller 17a can be provided configured to run along a running limb arranged or formed on the second guide rail 13a. Visible is the damping device 27 arranged on the column 14, the damping device 27 is provided for dampening a movement of the column 14 within an end position range being remote from the transfer position.

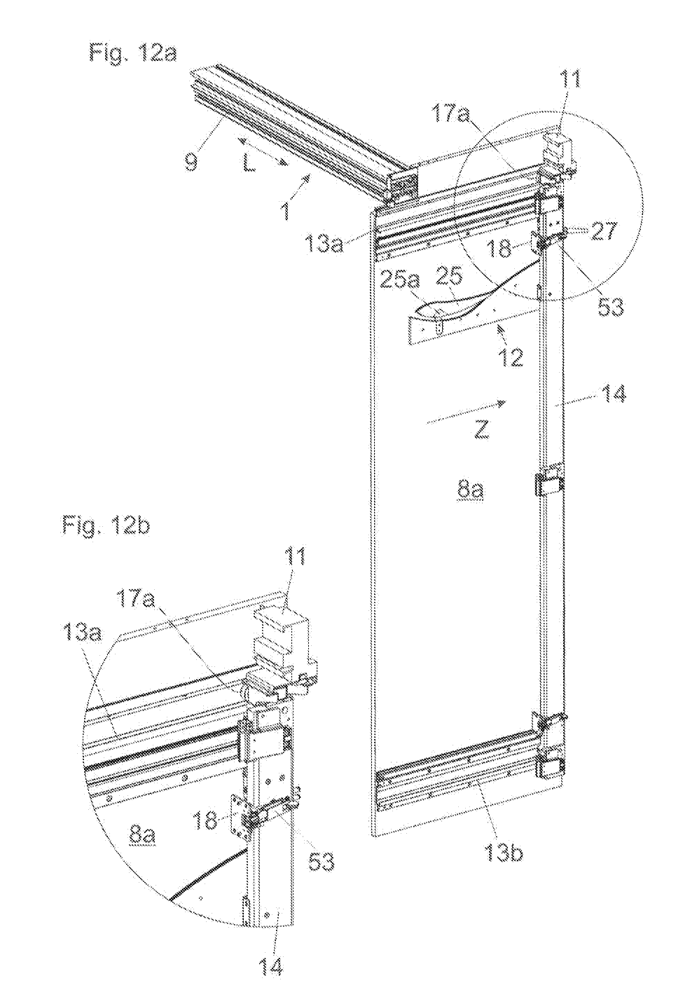

FIG. 12a shows the carrier 11 in a position remote from the first guide rail 9, and this position corresponds to the position of the furniture parts 3a, 3b when fully inserted into the insertion compartment 7a. Starting from the position shown in FIG. 12a, the furniture parts 3a, 3b can be ejected by the ejection devices 28 (not shown here) in a direction opposite the direction (Z). FIG. 12b shows the region encircled in FIG. 12a in an enlarged view.

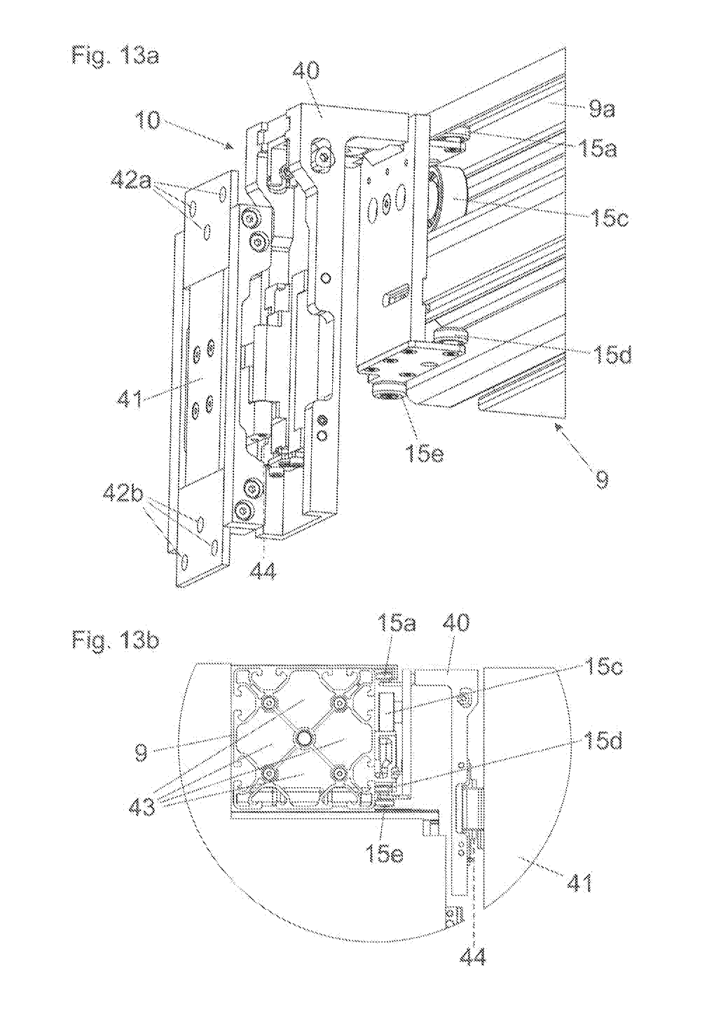

FIG. 13a shows a perspective view of the guiding device 10 movably supported on the first guide rail 9. The guiding device 10 can include a plurality of running rollers 15a, 15c, 15d, 15e having vertically and horizontally extending rotational axes, and the running rollers 15a, 15c, 15d, 15e are configured to run along a profiled section 9a of the first guide rail 9. The guiding device 10 includes a holding arm 40, and a fitting portion 41 configured to be fixed to the first furniture part 3a is pivotally connected to the holding arm 40 by a vertically extending pivoting axis 44 when mounted. The fitting portion 41 includes a plurality of fastening locations 42a, 42b for fixing to the first furniture part 3a.

FIG. 13b shows a cross-sectional view of the guiding device 10 movably supported on the first guide rail 9. The first guide rail 9, in a cross-sectional view, has a plurality of cavities 43 spaced from one another by profiled limbs. The running rollers 15a, 15c, 15d, 15e are configured to run along the first guide rail 9, and the fitting portion 41 configured to be fixed to the first furniture part 3a is pivotally connected to the holding arm 40 by the vertically extending pivoting axis 44.

FIG. 14a shows a possible embodiment of a spreading device 46 for spreading apart the furniture parts 3a, 3b, after having been moved out from the lateral insertion compartment 7b. The spreading device 46 includes a mounting portion 47 to be fixed to one of the furniture parts 3a, 3b, the mounting portion 47 has one or a plurality of bore(s) 52 for the passage of a screw. A spreading lever 49 is pivotally mounted about an axis 48 on the mounting portion 47. A spring element 50 (in this case a tension spring) is fixed to a bearing bolt 51 and pulls the spreading lever 49 continuously about the axis 48 in a direction of the depicted arrow. By the spreading device 46, the two furniture parts 3a, 3b continuously have the tendency to be spreaded apart. When now the furniture parts 3a, 3b are fully moved out from the lateral insertion compartment 7a, the furniture parts 3a, 3b, by virtue of the spring-loaded spreading lever 49, are spreaded apart, starting from a position in which the furniture parts 3a, 3b are aligned parallel to one another, into a further position in which the furniture parts 3a, 3b adopt an angled position to one another. The guiding device 10 connected to the first furniture part 3a can be displaced along the first guide rail 9 by a force of the spring element 50 and, as a result, also the second furniture part 3b is pulled therewith (FIG. 14b-14d).

FIG. 15a shows a possible embodiment of the second drive device 53 for driving the furniture parts 3a, 3b from a parallel or angled position into a coplanar position to one another. The second drive device 53 includes at least one actuating arm 67 connected to the second fitting portion 18, a spring device 59 for applying a force to the at least one actuating arm 67, a control curve 66 and a roller 61 pressurized by the spring device 59, and the roller 61 is configured to run along the control curve 66 upon a movement of the actuating arm 67. The second drive device 53 further includes a fitting portion 54 which is, for example, to be fixed to the vertically extending column 14. In this case, the fitting portion 54 has a two-part configuration and includes a first portion 54a to be fixed to the column 14 and a second portion 54b. A position of the second portion 54b relative to the first portion 54a can be adjusted by rotating an adjustment wheel 68. The second portion 54b is connected to an intermediate piece 63 by an axis 64, and the control curve 66 is formed or arranged on the intermediate piece 63. The intermediate piece 63 is connected to a housing portion 60 via a further axis 65, and the roller 61 is rotatably arranged on the housing portion 60 about an axis 62 and can be pressed against the control curve 66 by a force of the spring device 59. The housing portion 60 is configured so as to at least partially accommodate the spring device 59 and is displaceably mounted relative to the actuating arm 67, and the actuating arm 67 is hingedly connected via the axis 55 to the fitting portion 18 to be fixed to the second furniture part 3b. By an adjustment device 56 with an adjusting screw 57, a force of the spring device 59 applied to the second furniture part 3a can be adjusted. Upon a rotation of the adjusting screw 57 with the aid of a tool, an abutment element 58 can be adjusted along a threaded portion arranged on the adjusting screw 57. The spring device 59 is configured as a compression spring and is supported with a first end region on the abutment element 58 which, upon a rotation of the adjusting screw 57, can be adjusted along the threaded portion of the adjusting screw 57, whereby the spring device 59 is variably prestressed. The second end of the spring device 59 presses against the roller 61 configured to be displaced along the control curve 66 upon a movement of the actuating arm 67.

FIG. 15b shows the second drive device 53 according to FIG. 15a in a cross-sectional view, in which the roller 61 is releasably locked to a first locking section 66a of the control curve 66. As a result, the two furniture parts 3a, 3b, in the mounted condition, are held with a predetermined force in a coplanar position to one another. Here, the first locking section 66a of the control curve 66 is trough-shaped, and the roller 61 can be moved out from the trough-shaped locking section 66a by a movement of the fitting portion 18. After a holding force has been overcome, the roller 61 can further be moved along the control curve 66.

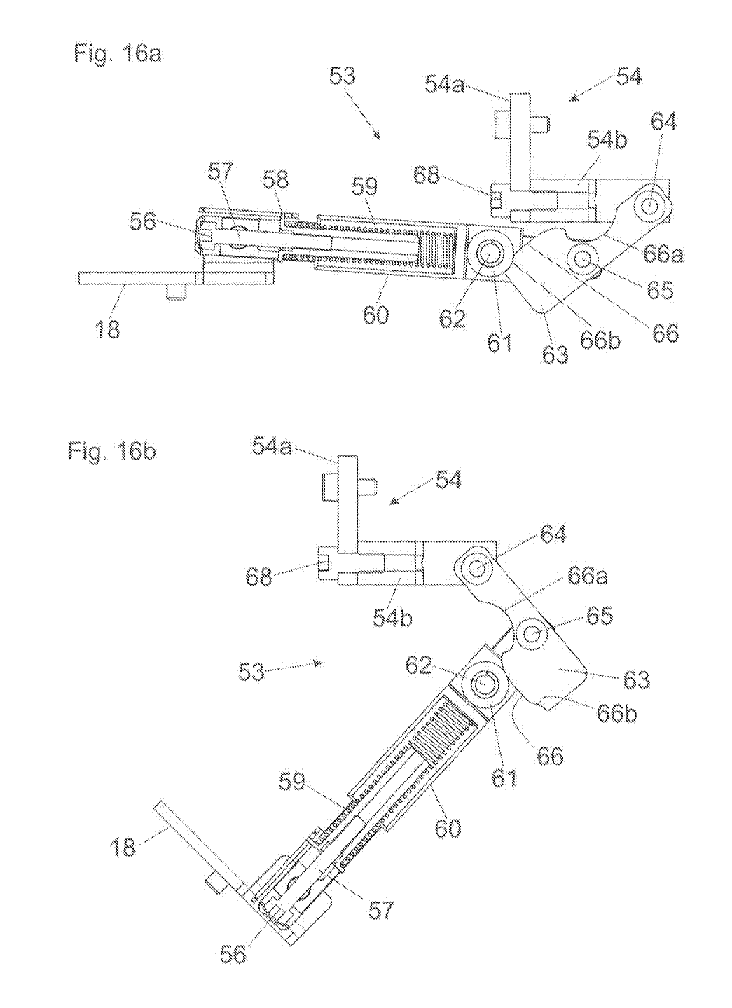

FIG. 16a shows a cross-sectional view of the second drive device 53 according to FIG. 15a and FIG. 15b, in which the fitting portion 18 is positioned such that the two furniture parts 3a, 3a are aligned parallel to one another in the mounted condition and can be moved into and out from the lateral insertion compartment 7a. The pressure roller 61 pressurized by the spring device 59 is thereby releasably locked to a second trough-shaped locking section 66b of the control curve 66, so that the two furniture parts 3a, 3b are held with a predetermined force in a parallel position to one another in the mounted condition. After moving out the furniture parts 3a, 3b from the lateral insertion compartment 7a, the furniture parts 3a, 3b can be spreaded apart, for example by the spreading device 46 shown in FIG. 14a, and the roller 61 is moved out from the second locking section 66b and, as shown in FIG. 16b, can further be moved along the control curve 66, and the furniture parts 3a, 3b can be moved from the parallel aligned position to one another in a direction towards the coplanar position.

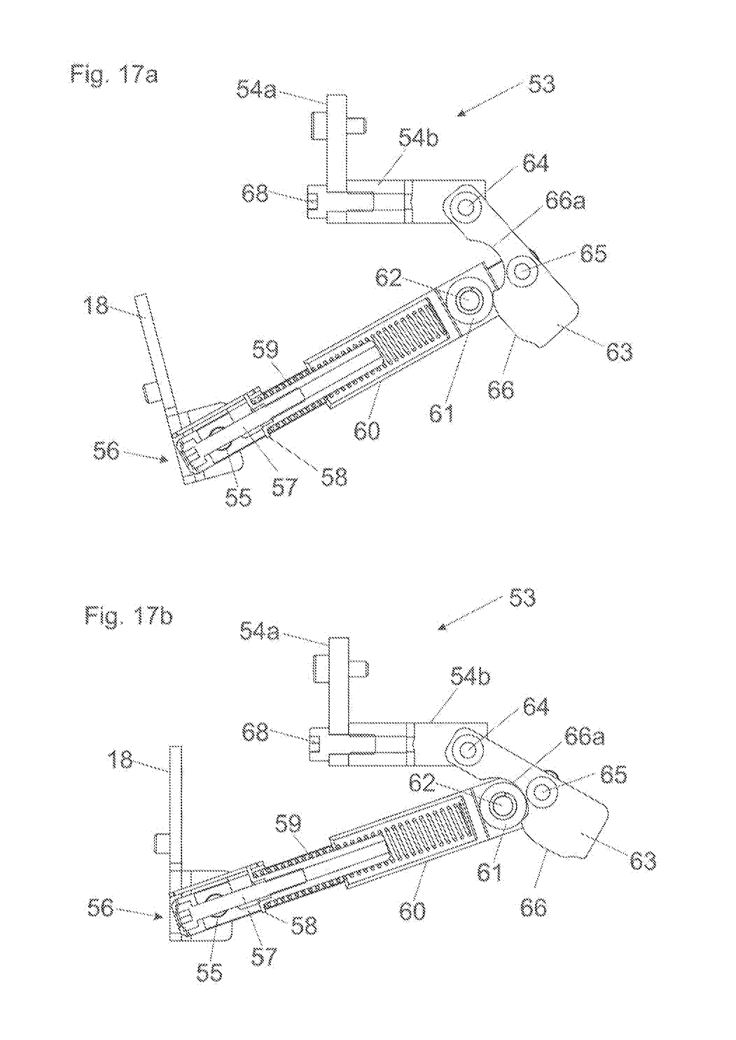

FIG. 17a shows, in comparison to FIG. 16a and FIG. 16b, continued movement of the second drive device 53, so that the two furniture parts 3a, 3b are also further moved in a direction towards the coplanar position. Upon an entry of the roller 61 into the first locking section 66a of the control curve 66, the spring device 59 configured as a compression spring can relax, so that the roller 61 is pressed into the first locking section 66a by a force of the expanding spring device 59, as shown in FIG. 17b. In this way, the fitting portion 18 (which is connected to the second furniture part 3b in the mounted condition) is also moved in a position in which the fitting portion 18 and the fitting portion 41 of the guiding device 10 (FIG. 13a) are aligned such that the furniture parts 3a, 3b, which are connected to the fitting portions 18, 41 in the mounted condition. are aligned substantially coplanar to each other.

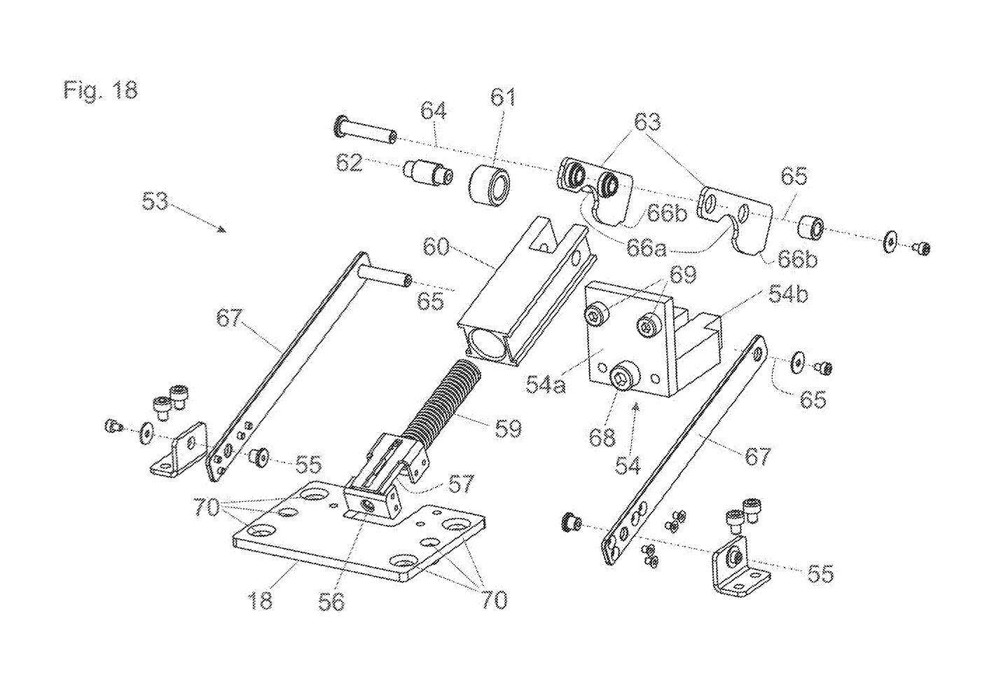

FIG. 18 shows the second drive device 53 in an exploded view. The second drive device 53 includes the fitting portion 18 to be fixed to the second furniture part 3b and a fitting portion 54 which is preferably to be fixed to the vertical column 14. The fitting portion 54 is hingedly connected to the intermediate piece 63 by the axis 64 and to the actuating arm 67 by the axis 65. The actuating arm 67 is pivotally connected to the fitting portion 18 by the axis 55. The fitting portion 18 includes at least one fastening location 70 for fixing to the second furniture part 3b, and the fitting portion 54 is to be mounted to the column 14 by at least one fastening means 69. The control curve 66 can be shaped such that the second furniture part 3b connected to the fitting portion 18 can be driven starting from a position, in which the two furniture parts 3a, 3b are aligned coplanar to one another, within an angle range starting from approximately 40° towards the aforementioned coplanar position by a force of the spring device 59.

### LIST OF REFERENCE NUMBERS

1 rail arrangement
2 guide system
3a, 3b furniture parts
4a, 4b furniture parts
5a, 5b vertical pivoting axes
6 furniture carcass
7a, 7b insertion compartments
8a, 8b side walls
9 first guide rail
9a profiled section of the guide rail
10 guiding device
11 carrier
11a profiled section of the carrier
12 retraction device
13a, 13b second guide rails
14 column
15a, 15b, 15c, 15d, 15e running rollers
16a, 16b guide channels
17a, 17b supporting rollers
18 fitting portion
19 pivoting axis of entrainment member
20 entrainment member
21 force storage members
22 pressure roller
23 control curve
23a retraction section of control curve
23b tensioning section of control curve
23c end section of control curve
24 bearing portion
25 switch member
25a pivoting axis of switch member
25c setting contour of switch member
26 stationary abutment portion 26
27 damping device
28 ejection devices
29 housing
30 locking device
31 pivoting axis of coupling lever
32 spacing roller
33 displacement piece
33a protrusion of displacement piece
34 recess of guide rail
35 coupling lever
35a counterstop of coupling lever
35c locking element of coupling lever
36 furniture carcass
37 item of furniture
38 abutment element of carrier
39 counterstop of guide rail
40 holding arm of guiding device
41 fitting portion of guiding device
42a, 42b fastening locations of guiding device
43 cavities of the guide rail
44 pivoting axis of fitting portion
45 crossing region
46 spreading device
47 mounting portion
48 axis
49 spreading lever
50 spring element
51 bearing bolt
52 bore
53 second drive device
54 fitting portion
55 axis
56 adjustment device
57 adjusting screw
58 abutment element
59 spring device
60 housing portion
61 roller
62 axis
63 intermediate piece
64 axis
65 axis
66 control curve
67 actuating arm
68 adjustment wheel
69 fastening means
70 fastening location

1. A guide system for guiding a movably-supported first furniture part, in particular a first door wing of a folding door, which is hingedly connected to at least one second furniture part, in particular a second door wing of a folding door, the guide system comprising:
a first guide rail for guiding the furniture parts,
a second guide rail for guiding the furniture parts, wherein the second guide rail, in the mounted position, extends transversely relative to the first guide rail,
a guiding device which is to be connected to the first furniture part, which is movable relative to the first and second guide rails and which has at least one fitting portion for fastening to the first furniture part,
a carrier which is displaceable relative to the second guide rail and which is connected to at least one second fitting portion for fastening to the second furniture part,
a first drive device for moving the guiding device, starting from the second guide rail, at least over a region in a direction towards the first guide rail,
wherein the guide system includes at least one second drive device for moving the guiding device, starting from the first guide rail, into a position in which the first fitting portion and the second fitting portion are aligned to each other such that the furniture parts, which are connected to the fitting portions in the mounting condition, are aligned substantially coplanar to each other.

2. The guide system according to claim 1, wherein the first drive device includes an entrainment member pressurized by at least one force storage member, wherein the carrier can be driven by the entrainment member in a direction extending transversely to the longitudinal direction of the first guide rail.

3. The guide system according to claim 2, wherein the entrainment member is configured to be releasably coupled to the guiding device, wherein the entrainment member is locked in a parking position and wherein the entrainment member can be unlocked by an entering movement of the guiding device starting from a crossing region—seen in a top view onto the first and second guide rail in the mounting position—so that the entrainment member, together with the guiding device coupled therewith, can be retracted at least over a region along the second guide rail by a force of the at least one force storage member.

4. The guide system according to claim 2, wherein the entrainment member includes a pivotally mounted pressure roller configured to run along a control curve.

5. The guide system according to claim 4, wherein the control curve includes a retraction section for at least partially retracting the carrier along the second guide rail, and a tensioning section adjoining the retraction section for loading the at least one force storage member.

6. The guide system according to claim 5, wherein the first drive device includes a movably mounted switch member with a setting contour arranged or formed thereon, wherein the pressure roller is configured to run along the setting contour of the switch member upon a movement of the carrier in a direction towards the first guide rail, so that the retraction section of the control curve can be bypassed by the pressure roller.

7. The guide system according to claim 1, wherein the guide system includes a spreading device by which the furniture parts connected to the fitting portions in the mounted condition can be spreaded apart from a parallel position to one another into an angled position to one another.

8. The guide system according to claim 7, wherein the spreading device includes a mounting portion to be fixed to one of the furniture parts, the mounting portion has a spreading lever pressurized by a spring element for spreading apart the furniture parts.

9. The guide system according to claim 1, wherein the second drive device is arranged on a column extending vertically in the mounting position, wherein the column is connected to the carrier and is movably mounted, together with the carrier, in a direction extending transversely to the longitudinal direction of the first guide rail.

10. The guide system according to claim 9, wherein the second drive device includes at least one actuating arm connected to the second fitting portion, a spring device for applying a force to the at least one actuating arm, a control curve and a roller pressurized by the spring device, wherein the roller is configured to run along the control curve upon a movement of the at least one actuating arm.

11. The guide system according to claim 10, wherein the control curve is arranged or formed on an intermediate piece, wherein the fitting portion to be fixed to the second furniture part is hingedly connected to a fitting portion by the intermediate piece, wherein it is preferably provided that the fitting portion is configured to be fixed to the column.

12. The guide system according to claim 1, wherein the carrier, in the mounting position, can be moved into a transfer position in which the carrier adjoins the first guide rail in the longitudinal direction, so that the guiding device can be transferred to and from between the first guide rail and the carrier.

13. An arrangement comprising a first furniture part and a second furniture part hingedly connected to one another by a pivoting axis, and a guide system according to claim 1 for guiding the furniture parts.

14. An item of furniture comprising the arrangement according to claim 13.

15. The item of furniture according to claim 14, wherein the item of furniture includes a furniture carcass being stationary during operation, and at least two furniture parts, in particular door wings of a folding door, movably supported relative to the furniture carcass, wherein the furniture parts are hingedly connected to one another by a pivoting axis extending vertically in the mounted position, wherein the at least two furniture parts can be moved by the guide system between a first position, in which the furniture parts are aligned substantially parallel to one another, and a second position, in which the furniture parts are aligned substantially coplanar to one another.
